(19) United States
(12) Patent Application Publication
(10) Pub. No.: US 2026/0034596 A1
(43) Pub. Date: Feb. 5, 2026

(54) Method For Honing a Gear with a Beveloid Toothing

(71) Applicant: Präwema Antriebstechnik GmbH, Eschwege/Werra (DE)

(72) Inventors: Jörg Schieke, Erfurt-Marbach (DE); Walter Holderbein, Eschwege (DE); Jörg Reinhardt, Berka v.d.H. (DE)

(21) Appl. No.: 19/289,171

(22) Filed: Aug. 4, 2025

(30) Foreign Application Priority Data
Aug. 5, 2024 (DE) 10 2024 122 256.5

(51) Int. Cl. B23F 19/05

(52) U.S. Cl. CPC B23F 19/055

(57) ABSTRACT

A method for honing a gear with a beveloid toothing, including the following steps; providing an at least in sections cylindrical honing tool and a gear to be honed, wherein the honing tool has a tool axis and a toothing, and wherein the gear has a workpiece axis and a beveloid toothing, honing the gear by means of the honing tool, wherein the honing tool and the gear are arranged with an axis cross angle to one another, wherein the honing tool and the gear are spaced apart from one another by a center distance at least in sections, and wherein the toothing of the honing tool and the beveloid toothing of the gear contact each other at least temporarily in at least one contact section. In order to simplify effective honing of beveloid toothing, it is proposed that the tool axis and the workpiece axis are spaced apart with an eccentricity at least in sections.

### CROSS-REFERENCE TO RELATED APPLICATION

This application claims priority to German Patent Application No. 10 2024 122 256.5 filed Aug. 5, 2024, the disclosure of which is hereby incorporated by reference in its entirety.

### BACKGROUND OF THE INVENTION

### Field of the Invention

The present invention relates to a method for honing a gear with a beveloid toothing, comprising the following steps: a) providing an at least in sections cylindrical honing tool and a gear to be honed, wherein the honing tool has a tool axis and a toothing, and wherein the gear has a workpiece axis and a beveloid toothing, b) honing the gear by means of the honing tool, wherein the honing tool and the gear are arranged with an axis cross angle to one another, wherein the honing tool and the gear are spaced apart from one another by an center distance at least in sections, and wherein the toothing of the honing tool and the beveloid toothing of the gear contact each other at least temporarily in at least one contact section.

### Description of Related Art

The structural design of a gearbox depends largely on the axis arrangement. The best-researched gear form in terms of design and production is the spur gear, which connects two parallel axes with a defined center distance. Bevel and hypoid gear sets are mainly used when two axes are to be connected at an angle of around 90°. However, especially for axis arrangements with shaft angles smaller than 20°, the production of bevel toothings with a very small pitch angle is not possible or very complex due to the production principle implemented in conventional bevel gear processing machines. In order to also make this shaft angle range, which is not covered by bevel gear sets, economically accessible, conical spur gears, which are known in particular as beveloid gears, are becoming increasingly important.

However, when manufacturing and machining beveloid gears, including honing, it must be taken into account that the conical shape of the toothing, in particular the conical root circle diameter mantle of the toothing, does not allow the transfer of conventional machining processes or does not lead to satisfactory results. If conventional honing processes were to be applied to beveloid toothing, the tool would collide with the conical root circle diameter mantle of the gear to be honed and/or the tool would not make area contact with the tooth flanks of the gear to be honed during machining.

From the prior art DE 10 2006 054 278 A1 is known for example. This document discloses a method for honing beveloid gears. However, one of the disadvantages of DE 10 2006 054 278 A1 is among other things that the honing tool has a conical shape. Therefore, in DE 10 2006 054 278 A1, the honing tool can only move along the tool axis or the gear along the workpiece axis to a limited extent during honing, as otherwise the toothing of the honing tool and gear would collide.

Against this background, the present invention is based on the object of providing a method for honing a gear with a beveloid toothing, which simplifies the effective honing of beveloid toothing.

### SUMMARY OF THE INVENTION

The aforementioned object is solved in accordance with the invention in that the tool axis and the workpiece axis are spaced apart from each other with an eccentricity at least in sections.

Various embodiments of the method are described in the following, wherein the individual embodiments can be combined with one another as desired.

The method for honing a gear with a beveloid toothing comprises the following step: a) providing an at least in sections cylindrical honing tool and a gear to be honed, wherein the honing tool has a tool axis and a toothing, and wherein the gear has a workpiece axis and a beveloid toothing. The cylindrical honing tool makes it easier for the tooth flanks of the honing tool and of the gear to be honed to contact each other continuously and not just at certain points during honing, especially when the honing tool moves along the tool axis relative to the gear to be honed. This is particularly the case if there is a tilt angle between the toothing of the honing tool and the beveloid toothing of the gear, wherein the tilt angle will be discussed below. The beveloid toothing of the gear to be honed preferably has a conical root circle diameter mantle, a cylindrical base circle diameter mantle and/or a cylindrical pitch circle diameter mantle at least in sections, in particular over the entire width of the beveloid toothing. Alternatively or additionally, the beveloid toothing of the gear to be honed can have a conical or cylindrical tip circle diameter mantle at least in sections, in particular over the entire width of the beveloid toothing. In step a), a gear processing machine can also be provided. This machine can enable fast and efficient honing. The tool axis is preferably the rotational axis and/or central axis of the honing tool and/or the workpiece axis is preferably the rotational axis and/or central axis of the workpiece. Advantageously, it may be provided that the width of the honing tool, preferably along the tool axis, is wider than the width of the gear, preferably along the workpiece axis. Alternatively or additionally, it may be provided that the width of the honing tool, preferably along the tool axis, corresponds to at least 1.0 times, preferably at least 2.0 times, the module of the beveloid toothing of the gear. This provides a honing tool that simplifies machining as efficiently as possible.

The mantles described in this disclosure are each the mantle or the mantle surface which is formed along the width of the honing tool and/or the gear to be honed, preferably the width of the respective toothing of the honing tool and/or the gear to be honed, for the diameters mentioned in each case.

The method also comprises the following step: b) honing the gear by means of the honing tool, wherein the honing tool and the gear are arranged with an axis cross angle to one another, wherein the honing tool and the gear are spaced apart from one another by a center distance at least in sections, and wherein the toothing of the honing tool and the beveloid toothing of the gear contact each other at least temporarily in at least one contact section. This brings the gear to be honed and the honing tool into a position that simplifies effective machining. The cutting speed can be adjusted during honing by means of the axis cross angle. The axis cross angle is preferably greater than 0° so that a sufficient cutting speed is available. Advantageously, the tool axis and the workpiece axis are spaced apart from each other by the center distance and/or the tool axis and the workpiece axis are arranged with the axis cross angle to one another. The center distance is preferably greater than 0 mm. The toothing of the honing tool and/or the beveloid toothing of the gear each comprise at least one tooth, preferably a plurality of teeth, with at least one tooth flank, preferably two tooth flanks, per tooth. In step b), the at least one tooth, preferably the tooth flank of the at least one tooth, of the beveloid toothing is preferably honed.

The contact section is preferably located in the engagement area of the toothing of the honing tool and the beveloid toothing of the gear to be honed, wherein the contact section comprises a primary contact section at the honing tool and/or a secondary contact section at the gear to be honed. Advantageously, the primary contact section comprises the at least one contact line on the toothing of the honing tool and/or the secondary contact section comprises the at least one contact line on the beveloid toothing of the gear to be honed

Advantageously, it can be provided that in step b) the honing tool and/or the gear are arranged on the gear processing machine and/or the honing is carried out by means of the gear processing machine. The gear processing machine can be used to quickly and precisely align the honing tool and the gear in relation to each other and to quickly and precisely process the gear.

The method also provides for the tool axis and the workpiece axis to be spaced apart with an eccentricity at least in sections. This sets a tilt angle in the form of a kinematic angle of inclination between the toothing of the honing tool and the beveloid toothing of the gear to be honed. This in turn has the consequence, in particular in conjunction with the cylindrical honing tool, that during honing, in particular when the honing tool moves along the tool axis relative to the gear to be honed, the tooth flanks of the honing tool and of the gear to be honed contact each other continuously and not just at certain points. In addition, the tilt angle prevents a collision between the toothing of the honing tool and the beveloid toothing of the gear during honing, despite the conical root circle diameter mantle of the beveloid toothing. The eccentricity is the distance between the center plane of the gear and the tool axis reference point of the honing tool. The center plane of the gear runs through the workpiece axis And/or parallel to the center distance direction, i.e. parallel to the direction along which the center distance runs. The tool axis reference point is arranged in the cylindrical section of the honing tool, preferably in the cylindrical section of the toothing of the honing tool, and/or the tool axis reference point is arranged on the tool axis, preferably in the area of the toothing of the honing tool and/or in the area of the contact section, in particular in the center of the toothing of the honing tool along the tool axis and/or in the center of the contact section along the tool axis. The eccentricity can preferably be set in step b). To achieve the described tilt angle, it is not necessary to tilt the honing tool and/or the gear by means of a machine axis of a gear processing machine, so that a structurally simpler gear processing machine with few adjustable machine axes can also be used. Due to the eccentricity, at least one of the pivot axes can be dispensed with in a conventional gear processing machine, for example, and thus preferably one machine axis can be saved.

According to an embodiment, it is provided that the axis cross angle is greater than 0°, preferably at least 5°, in particular at least 10°, and/or at most 25°, preferably at most 20°, in particular at most 15°. In this way, an axis cross angle is set which leads to an advantageous cutting speed for honing.

According to an embodiment, it is provided that the honing tool, preferably the toothing of the honing tool, has at least one cylindrical section, and that the cylindrical section has a cylindrical tip circle diameter mantle, a cylindrical base circle diameter mantle, a cylindrical pitch circle diameter mantle and/or a cylindrical root circle diameter mantle and/or in step b) the contact section is arranged in the cylindrical section. This provides a honing tool with a cylindrical toothing, which simplifies continuous contact during honing in the contact section.

According to an embodiment, it is provided that in step b) the tooth flank of at least one tooth of the toothing of the honing tool and the tooth flank of at least one tooth of the beveloid toothing of the gear contact each other, preferably in the contact section, and/or that in step b) there is a line contact in the contact section between the toothing of the honing tool and the beveloid toothing of the gear, preferably the tooth flank of the at least one tooth of the toothing of the honing tool and the tooth flank of the at least one tooth of the beveloid toothing of the gear. This makes it easier to achieve a continuous contact in the contact section during honing. The extent of the line contact preferably corresponds to at least 0.5 times, preferably at least 0.75 times, in particular at least 1.0 times, the width of the cylindrical section of the toothing of the honing tool, preferably the width of the cylindrical section of the toothing of the honing tool along the tool axis, and/or the extent of the line contact corresponds to the width, preferably along the tool axis, of the overlap of the toothing of the honing tool and the beveloid toothing of the gear.

According to an embodiment, it is provided that the shape of the two tooth flanks of at least one tooth, preferably the shape of the two tooth flanks of respectively all teeth, of the toothing of the honing tool is asymmetrical to one another. This makes it easier to achieve a continuous contact in the contact section during honing despite the beveloid toothing of the gear to be honed and the tilt angle. It is particularly advantageous here if the base circle diameter and/or the pressure angle of the two tooth flanks of at least one tooth, preferably of the two tooth flanks of respectively all teeth, of the toothing of the honing tool are different. This makes it even easier to achieve a continuous contact during honing in the contact section between the honing tool and the gear.

According to an embodiment, it is provided that in step b) the gear and the honing tool are displaced relative to one another, preferably the gear is moved along the workpiece axis, preferably forwards and backwards, and/or the honing tool is moved along the tool axis, preferably forwards and backwards. This creates an oscillating and/or linear movement during honing, which simplifies efficient honing. The movement of the gear and the honing tool relative to each other, preferably the movement of the honing tool and/or the gear, can advantageously be generated by the gear processing machine. The relative movement between the gear and the honing tool can preferably take place at a speed, preferably feed speed, of at least 50 mm/min, preferably at least 100 mm/min, in particular at least 150 mm/min, and/or of at most 500 mm/min, preferably at most 450 mm/min, in particular at most 400 mm/min.

According to an embodiment, it is provided that in step b) the gear and the honing tool rotate relative to one another, preferably the gear rotates about the workpiece axis and/or the honing tool rotates about the tool axis. This creates a rotating movement during honing, which simplifies efficient honing. The rotation of the gear and the honing tool relative to one another, preferably the rotation of the honing tool and/or of the gear, can advantageously be generated by the gear processing machine. The honing tool can preferably rotate in step b) at a rotational speed of at least 500 1/min, preferably at least 2500 1/min, in particular at least 5000 1/min, and/or at most 15000 1/min, preferably at most 12500 1/min, in particular at most 10000 1/min. Alternatively or additionally, the gear can preferably rotate at a corresponding rotational speed adapted to the gear ratio between the toothing of the honing tool and the beveloid toothing of the gear in step b).

According to an embodiment, the method comprises step a1): Providing a gear processing machine. Fast and efficient honing can be achieved using a gear processing machine. The honing tool and/or the gear can be arranged at the gear processing machine in step b), preferably mounted at the gear processing machine.

In addition, it is provided that the gear processing machine has at least one translational axis, preferably at least two translational axes, wherein the honing tool and/or the gear can be displaced along the at least one translational axis, preferably the at least two translational axes. In this way, at least one translational movement of the honing tool and/or the gear can be achieved by means of the gear processing machine, for example to adjust the center distance and/or the eccentricity. In addition, the gear processing machine can have at least one rotational axis, preferably at least two rotational axes. This allows the honing tool and/or the gear to be rotated by means of the gear processing machine. Alternatively or additionally, the gear processing machine can have at least one pivot axis, which can be used to pivot the honing tool and the gear relative to each other, for example to set the axis cross angle. The at least one translational axis, preferably the at least two translational axes, the at least one rotational axis, preferably the at least two rotational axes, and/or the at least one pivot axis preferably can respectively be a machine axis of the gear processing machine.

According to an embodiment, it is provided that, preferably in step b), the eccentricity is set, preferably exclusively, by means of a displacement of the honing tool and/or the gear, preferably along the translational axis, in particular one of the two translational axes. To achieve the tilt angle described above, it is therefore not necessary to tilt the honing tool and/or the gear by means of a machine axis of a gear processing machine, so that a structurally simpler gear processing machine with fewer adjustable machine axes can also be used. Due to the eccentricity, at least one pivot axis can be dispensed with in a conventional gear processing machine, for example. The displacement is preferably a displacement of the honing tool relative to the gear and/or a displacement of the gear relative to the honing tool. Preferably, the tilt angle is a different angle than the axis cross angle and/or is provided in addition to the axis cross angle. The tilt angle can preferably be between the tool axis and the workpiece axis.

Alternatively or additionally, it may be provided that, preferably in step b), a tilt angle between the toothing of the honing tool and the beveloid toothing of the gear is set, preferably exclusively, by means of a displacement of the honing tool and/or the gear, preferably along the translational axis, in particular one of the two translational axes. In this way, particularly in conjunction with the cylindrical honing tool, it can be achieved that during honing, especially when the honing tool moves along the tool axis relative to the gear to be honed, the tooth flanks of the honing tool and of the gear to be honed contact each other continuously and not just at certain points. In addition, the tilt angle prevents a collision between the toothing of the honing tool and the beveloid toothing of the gear during honing, despite the conical root circle diameter of the beveloid toothing. The tilt angle can preferably be a kinematic angle of inclination between the toothing of the honing tool and the beveloid toothing of the gear to be honed. The displacement is preferably a displacement of the honing tool relative to the gear and/or a displacement of the gear relative to the honing tool. Preferably, the tilt angle is a different angle than the axis cross angle and/or is provided in addition to the axis cross angle. The tilt angle can preferably be between the tool axis and the workpiece axis.

Alternatively or additionally, it can also be provided that, preferably in step b), the tilt angle is not set by means of a pivoting of the honing tool and/or the gear, preferably about a pivot axis of the gear processing machine. In this way, the tilt angle, preferably in the form of a kinematic angle of inclination, between the honing tool and the gear can be set in a simple manner, in particular without pivoting the honing tool and/or the gear.

### BRIEF DESCRIPTION OF THE DRAWINGS

Further features and advantages of the method are shown in the following description of exemplary embodiments, with reference being made to the attached drawing.

The drawing shows

FIG. 1 a honing tool and a gear to be honed in engagement with each other in a front view of the gear, and

FIG. 2 the honing tool and the gear to be honed from FIG. 1 in a side view of the gear,

FIG. 3 the honing tool and the gear to be honed from FIG. 1 in a front view of the honing tool, and

FIG. 4 The honing tool and the gear to be honed from FIG. 1 in a sectional top view of the honing tool.

### DESCRIPTION OF THE INVENTION

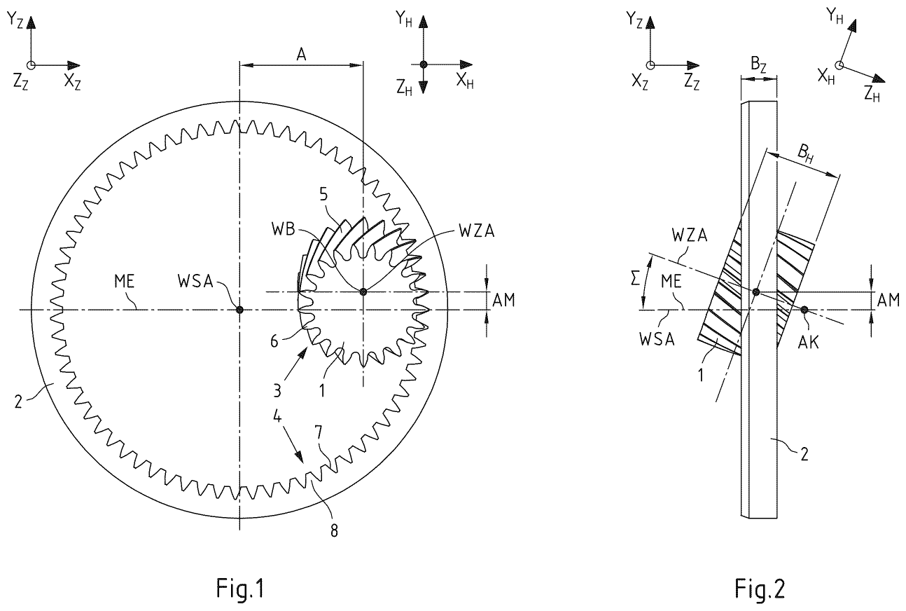

FIG. 1 shows a honing tool 1 and a gear 2 to be honed in engagement with each other in a front view of the gear. The honing tool 1 is cylindrical and has a toothing 3. In the alignment of the honing tool 1 and the gear 2 shown in FIG. 1, the toothing 3 of the honing tool 1 contacts the beveloid toothing 4 of the gear 2 to be honed. In this case, at least one tooth flank 5 of at least one tooth 6 of the toothing of the honing tool 1 and at least one tooth flank 7 of at least one tooth 8 of the beveloid toothing 4 of the gear 2 contact each other in a contact section. The honing tool 1, in particular the tool axis WZA of the honing tool 1, is spaced apart from the gear 2, in particular the workpiece axis WSA of the gear 2, by a center distance A. In addition, the honing tool 1, in particular the tool axis WZA of the honing tool 1, is arranged with an axis cross angle Σ with respect to the gear 2, in particular the workpiece axis WSA of the gear 2 (the axis cross angle Σ is shown in FIG. 2). During honing, the honing tool 1 is moved back and forth along the tool axis WZA and the honing tool 1 and the gear 2 are moved relative to each other.

The honing tool 1 of the embodiment shown has a toothing 3 with a cylindrical tip circle diameter mantle, a cylindrical base circle diameter mantle, a cylindrical pitch circle diameter mantle and a cylindrical root circle diameter mantle over the entire width of the toothing 3. In the embodiment shown, the width B_{H} of the toothing 3 of the honing tool 1 (not to be confused with the tooth width) is therefore identical to the width of the honing tool 1. Similarly, in the embodiment shown, the width B_{Z} of the beveloid toothing 4 of the gear 2 is identical to the width of the gear 2. However, it may also be provided, for example, that only a part of the honing tool 1 in the form of a cylindrical section has a corresponding toothing 3.

The beveloid toothing 4 of the gear 2 shown again has a conical root circle diameter mantle, which is why it is advantageous for efficient and collision-free honing if there is a tilt angle θ between the toothing 3 of the honing tool 1 and the beveloid toothing 4 of the gear 2. In order to achieve this in a structurally uncomplicated manner, the honing tool 1, in particular the tool axis WZA of the honing tool 1, and the gear 2, in particular the workpiece axis WSA of the gear 2, are spaced apart with an eccentricity AM. This results in a tilt angle θ between the toothing 3 of the honing tool 1 and the beveloid toothing 4 of the gear 2 in the form of a kinematic angle of inclination. The eccentricity AM is the distance between the center plane ME of the gear 2 and the tool axis reference point WB of the honing tool 1.

For a better understanding of the alignment of the honing tool 1 and the gear 2, FIGS. 1 to 4 each show the alignment of the honing tool 1 using a separate coordinate system comprising the axes X_{H}, Y_{H}, Z_{H} and the alignment of the gear 2 using a separate coordinate system comprising the axes X_{Z}, Y_{Z}, Z_{Z}. The workpiece axis WSA runs parallel to the axis Z_{Z} and the tool axis WZA runs parallel to the axis Z_{H}. Due to the axis cross angle Σ and the tilt angle θ described below, the honing tool 1 and the gear 2 are tilted towards each other, with the tilt angle θ simplifying the area contact between the toothings 3, 4.

FIG. 2 shows the honing tool 1 and the gear 2 to be honed from FIG. 1 in a side view of the gear. The axis cross angle Σ is clearly visible in this view, as is the resulting alignment of the tool axis WZA and workpiece axis WSA to each other. The tool axis WZA and the workpiece axis WSA intersect at the axis cross point AK. However, due to the arrangement of the honing tool 1 and the gear 2, the axis cross point AK is not located in the area of the contact section between the toothing 3 of the honing tool 1 and the beveloid toothing 4 of the gear 2, as is usually the case during honing, but outside of this area. In order to set this arrangement of the axis cross point AK and the resulting tilt angle θ, the honing tool 1 is offset by the eccentricity AM relative to the gear 2. In the embodiment shown, this can be achieved, for example, by displacing the honing tool 1 along a translational axis, for example a vertical machine axis, of a gear processing machine at which the honing tool 1 and the gear 2 are arranged for the honing. In the embodiment shown, the translational axis along which the honing tool 1 and the gear 2 were displaced is the Y-axis Y_{Z} of the gear 2. By setting the eccentricity AM in this way, an additional machine axis for generating a tilt can be dispensed with. Alternatively or additionally, it would also be conceivable to displace the honing tool 1 and/or the gear 2 linearly along their respective axes WZA, WSA when the axis cross angle Σ is set, in order to generate the eccentricity AM.

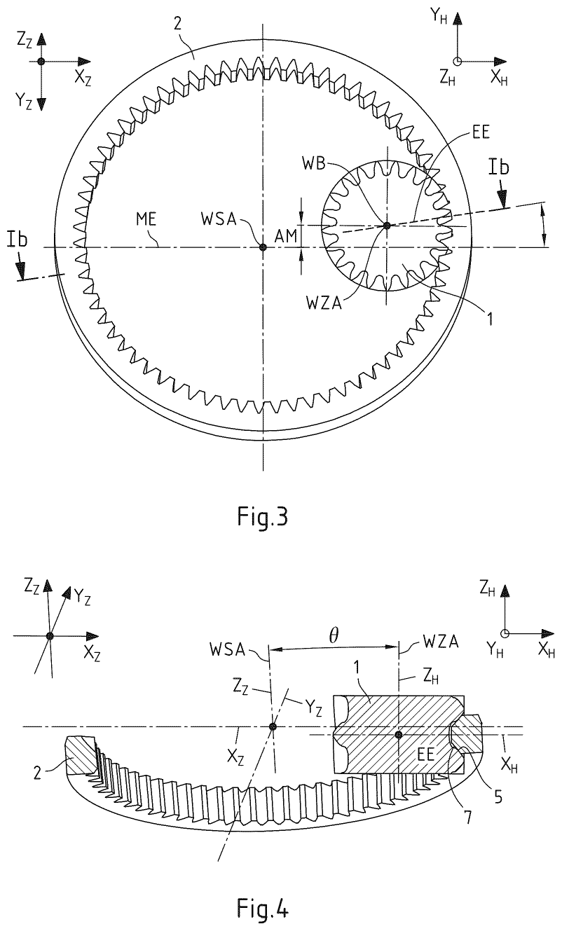

FIG. 3 shows the honing tool 1 and the gear 2 to be honed from FIG. 1 in a front view of the honing tool 1. The position angle κ between the toothing 3 of the honing tool 1 and the beveloid toothing 4 of the gear 2 is shown here. The position angle κ preferably corresponds to the angle between a line that runs through the center plane ME and parallel to the axis X_{H} relative to a line that runs through the tool axis reference point WB and the contact point of the toothing 2 and the beveloid toothing 4, preferably in the plane spanned by the axes X_{H} and Y_{H}. The plane EE extends along the position angle κ and through the tool axis WZA, through which plane EE the section Ib-Ib runs, which is shown in FIG. 4 following.

FIG. 4 shows the honing tool 1 and the gear 2 to be honed from FIG. 1 in a sectional top view of the honing tool 1. It can be seen in this section that the tool axis WZA and the workpiece axis WSA are tilted relative to each other by the tilt angle θ in addition to the axis cross angle Σ. The tilt angle θ is created by the eccentricity AM and the tilt angle θ, in particular in conjunction with the cylindrical honing tool 1, result in that during honing, especially when the honing tool 1 moves along the tool axis WZA relative to the gear 2 to be honed, the tooth flanks 5 of the honing tool 1 and the tooth flank 7 of the gear 2 to be honed make continuous and area contact and not just point contact. In addition, the tilt angle θ prevents a collision between the toothing 3 of the honing tool 1 and the beveloid toothing 4 of the gear 2 during honing, despite the conical root circle diameter of the beveloid toothing 4, when the honing tool 1 and gear 2 are moved relative to each other. In the section shown in FIG. 4, it can be clearly seen that the tooth flanks 5 of the honing tool 1 and the tooth flank 7 of the gear 2 are already in area contact in this section and not just at certain points, with the contact section extending even further along the respective tooth width of the toothing 3 of the honing tool 1 and the tooth width of the beveloid toothing 4 of the gear 2.

### LIST OF REFERENCE SIGNS

1 Honing tool
2 Gear
3 Toothing of the honing tool
4 Beveloid toothing of the gear
5 Tooth flank
6 Tooth of the toothing of the honing tool
7 Tooth flank
8 Tooth of the beveloid toothing of the gear
A Center distance
AM Eccentricity
AK Axis cross point
B_{H} Width of the toothing of the honing tool
B_{Z} Width of the beveloid toothing of the gear
EE Plane
ME Center plane
WB Tool axis reference point
WSA Workpiece axis
WZA Tool axis
Σ Axis cross angle
κ Position angle
θ Tilt angle

1. A method for honing a gear with a beveloid toothing, comprising the following steps:
a) Providing an at least in sections cylindrical honing tool and a gear to be honed,
wherein the honing tool has a tool axis and a toothing, and
wherein the gear has a workpiece axis and a beveloid toothing,
b) Honing the gear by means of the honing tool,
wherein the honing tool and the gear are arranged with an axis cross angle to one another,
wherein the honing tool and the gear are spaced apart from one another by a center distance at least in sections, and
wherein the toothing of the honing tool and the beveloid toothing of the gear contact each other at least temporarily in at least one contact section,
wherein
the tool axis and the workpiece axis are spaced apart with an eccentricity at least in sections.

2. The method according to claim 1,
wherein
the axis cross angle is greater than 0°, preferably at least 5°, in particular at least 10°, and/or at most 25°, preferably at most 20°, in particular at most 15°.

3. The method according to claim 1,
wherein
the honing tool, preferably the toothing of the honing tool, has at least one cylindrical section, and in that
the cylindrical section has a cylindrical tip circle diameter mantle, a cylindrical base circle diameter mantle, a cylindrical pitch circle diameter mantle and/or a cylindrical root circle diameter mantle, and/or
in step b) the contact section is arranged in the cylindrical section.

4. The method according to claim 1,
wherein
in step b), the tooth flank of at least one tooth of the toothing of the honing tool and the tooth flank of at least one tooth of the beveloid toothing of the gear contact each other, preferably in the contact section, and/or that in step b) there is a line contact in the contact section between the toothing of the honing tool and the beveloid toothing of the gear, preferably the tooth flank of the at least one tooth of the toothing of the honing tool and the tooth flank of the at least one tooth of the beveloid toothing of the gear.

5. The method according to claim 1,
wherein
the shape of the two tooth flanks of at least one tooth, preferably the shape of the two tooth flanks of respectively all teeth, of the toothing of the honing tool is asymmetrical to one another.

6. The method according to claim 1,
wherein
in step b) the gear and the honing tool are displaced relative to one another, preferably the gear is moved along the workpiece axis, preferably forwards and backwards, and/or the honing tool is moved along the tool axis, preferably forwards and backwards.

7. The method according to claim 1,
wherein
in step b) the gear and the honing tool rotate relative to one another, preferably the gear rotates about the workpiece axis and/or the honing tool rotates about the tool axis.

8. The method according to claim 1,
characterized by
the step a1):
Providing a gear processing machine,
wherein the gear processing machine has at least one translational axis, preferably at least two translational axes, and, preferably, at least one rotational axis, in particular at least two rotational axes and/or at least one pivot axis, and
wherein the honing tool and/or the gear can be displaced along the at least one translational axis, preferably the at least two translational axes.

9. The method according to claim 1,
wherein
preferably in step b), the eccentricity is set, preferably exclusively, by means of a displacement of the honing tool and/or of the gear, preferably along the translational axis, in particular one of the two translational axes, in that, preferably in step b), a tilt angle between the toothing of the honing tool and the beveloid toothing of the gear is set, preferably exclusively, by means of a displacement of the honing tool and/or the gear, preferably along the translational axis, in particular one of the two translational axes, and/or that the tilt angle, preferably in step b), is not set by means of a pivoting of the honing tool and/or the gear, preferably about a pivot axis of the gear processing machine.
